(19) United States
(12) Patent Application Publication
(10) Pub. No.: US 2014/0102490 A1
(43) Pub. Date: Apr. 17, 2014

(54) APPARATUS FOR WASHING OBJECT TO BE WASHED

(71) Applicant: Masahide Uchino, Tokyo (JP)

(72) Inventor: Masahide Uchino, Tokyo (JP)

(73) Assignee: JAPAN FIELD CO., LTD., Tokyo (JP)

(21) Appl. No.: 14/004,590

(22) PCT Filed: Jan. 10, 2012
(86) PCT No.: PCT/JP2012/000082

§ 371 Date: Nov. 14, 2013

(30) Foreign Application Priority Data
Mar. 17, 2011 (JP) 2011-059617

(51) Int. Cl. B08B 3/04

(52) U.S. Cl. CPC B08B 3/04
USPC 134/133

(57) ABSTRACT

[Problem] Since a working chamber for performing an operation of washing an object to be washed is provided so as to move vertically in a washing tank and be separated from the washing tank and airtightly shut off, a minimal space required for an operation of washing the object to be washed such as drying under reduced pressure can be provided, and drying under reduced pressure can be efficiently performed in the presence of washing liquid or washing vapor in the washing tank without unnecessary burden on a reduced pressure system.

[Solution] A pressure-resistant working chamber 2 which can move vertically in a washing tank 1, has an opening part 22 capable of opening and closing on the side face in a direction of vertical movement, and loads an object 12 to be washed is provided. A covering part 24 by which the working chamber 2 can be sealed by covering the opening part 22 provided on the side of the working chamber 2 and can be depressurized by being connected to a reduced pressure system 27 is provided in the inner face of the washing tank 1 so as to move horizontally.

### TECHNICAL FIELD

The present invention relates to an apparatus for washing an object to be washed, which aims to enable by a small apparatus and easily an operation of washing an object to be washed by using reduced pressure, and to enable performing easily and reliably multiple kinds of washing operations in accordance with the washing purpose.

### BACKGROUND ART

When conventionally performing immersion washing, vapor washing, reduced pressure drying etc. of an object to be washed, there exist cases where these washing procedures are performed in separate washing tanks, and where all washings are performed in a single washing tank. In case of performing immersion washing, vapor washing, reduced pressure drying and the like in separate washing tanks, each washing tank can be configured for a single function, which enables the configuration of each apparatus to be simplified while making it possible to obtain an excellent washing effect with respect to each operation. However, due to using multiple washing tanks apparatuses become bulky and expensive, at the same time having the disadvantage to cause spreading of solvent vapor because objects to be washed are transferred between the washing tanks.

Further, with the goal of eliminating the above drawbacks, there exist attempts to perform multiple washing operations such as immersion washing, vapor washing, reduced pressure drying and so on in a single washing tank. In order to carry out reduced pressure drying in a single washing tank after immersion washing or vapor washing an object to be washed, it is necessary to shut off the location for performing the reduced pressure drying from the section accommodating the washing liquid. The reason is that, unless this shut-off is performed, washing liquid is volatilized without limit under the reduced pressure, such that reliable reduced pressure drying becomes difficult and a heavy load is placed on the reduced pressure system.

Therefore, as shown in Patent Documents 1 and 2, attempts are known to shut off the washing liquid accommodating section from a drying section for the object to be washed, in order to perform a drying operation on the object to be washed in the drying section, through partitioning the washing liquid accommodating section and the drying section for the object to be washed by a gate valve that is inserted from a side face of the washing tank. Further, as shown in Patent Document 3, an attempt is known to shut off the washing liquid accommodating section from a drying section for the object to be washed, in order to perform a drying operation on the object to be washed in the drying section, through pressing a covering plate, which is disposed in advance in the washing liquid side of the washing tank, against a packing of an annular flange which is arranged higher than the liquid level of the washing liquid in the washing tank.

### PRIOR ART DOCUMENTS

### Patent Documents

Patent Document 1: JP 7 227581 A

Patent Document 2: JP 6 15239 A Patent Document 3: JP 2000 160378 A

### OUTLINE OF THE INVENTION

### Problem to Be Solved By the Invention

However, because the inventions according to Patent Documents 1 and 2 partition the washing liquid accommodating section and the drying section for the object to be washed by a gate valve that is inserted from a side face of the washing tank, the gate valve becomes a large projection at the side face of the washing tank, which is undesirable because it makes the apparatus bulky. A further drawback is that swarf and sludge having separated from the object to be washed due to washing adhere to the sliding surface of the gate valve, impairing the airtightness. The probability that the sealing portion becomes damaged by the sliding motion of the gate valve is high.

Further, while the invention shown in Patent Document 3 does not cause disadvantages such as described above, it attempts to form an airtight chamber for performing reduced pressure drying of the object to be washed by pressing the covering plate against the packing of the annular flange, which is arranged higher than the liquid level in the washing tank. Now, because the airtight chamber for performing reduced pressure drying of the object to be washed is formed by partitioning the washing tank in the invention shown in Patent Document 3 as well as in the inventions of Patent Documents 1 and 2, largely the washing tank itself comes to be utilized. As a result, because the washing tank with washing liquid and condensation liquid adhering to its inner surface due to immersion washing, vapor washing and the like is used in unchanged condition for performing reduced pressure drying, an excessive load on the reduced pressure system is generated and the reduced pressure drying becomes inefficient.

Further, since the inventions shown in Patent Documents 1 to 3 transversely partition the washing tank, it is not possible to set the size of the reduced pressure drying chamber arising from the shut-off to less than the transverse diameter of the washing tank. Therefore, a drying chamber is formed of a size that is unnecessary for the reduced pressure drying of the object to be washed, thereby unfavorably making the apparatus bulky, placing an additional load on the reduced pressure system, and compromising the depressurization efficiency because the volume subject to depressurization is made unnecessarily large.

Accordingly, the present invention has been made to try to resolve the problems such as described above, forming a reduced pressure drying unit completely separate from the washing tank, to enable reduced pressure drying of an object to be washed by depressurizing the minimum space that is required, together with enabling the depressurizable space to be used for various washing operations apart from reduced pressure drying. It is also intended to form a reliable airtight state during the reduced pressure drying, so that there is no occurrence of leaking against the airtightness.

### Means for Solving the Problems

In order to solve the problems such as described above, the present invention provides, separately from a washing tank for loading a washing liquid for an object to be washed into a bottom base thereof, a pressure-resistant working chamber for loading the object to be washed, wherein the working chamber is movable vertically within the washing tank and has an openable and closable opening part formed in a side face in the vertical movement direction. The working chamber is formed in a tubular shape such as a circular tube shape or an angular tube shape, the opening part being provided in a side face in the vertical movement direction of the tubularly shaped working chamber. Furthermore provided is a covering part for enabling an interior of the working chamber to be sealed by covering the opening part in the side face of the working chamber, and for enabling the interior of the working chamber to be depressurized by connecting the interior of the working chamber to a reduced pressure system.

The washing tank that houses the vertically movable working chamber may be provided with pressure resistance, or may be configured without comprising pressure resistance for use at atmospheric pressure, which is arbitrarily selectable according to the operation purpose.

The opening part of the working chamber is formed vertically on the side face of the tubular working chamber. By forming in this way the opening part vertically on the side face of the working chamber, swarf and sludge, which due to the washing operation separate from the object to be washed, become difficult to pile up or get caught in the opening part or a packing provided at the opening part, such that causing poor airtightness when being sealed by the covering part is enabled to be prevented.

The opening part of the working chamber may provided as a pair on opposite sides of the working chamber, or may also be provided singly on only one side of the working chamber. If providing opening parts on two opposite sides of the working chamber, the loading and unloading of objects to be washed to the working chamber becomes easy, enabling to improve the operability. Again, if the opening part is singly provided on only one side of the working chamber, the covering part as well does have to be provided only singly, such that the configuration of the apparatus is enabled to be simplified and an inexpensive apparatus can be obtained. Furthermore, selecting only one opening part and covering part enables to enhance the effect of preventing leaks against airtightness.

Further, the covering part may be provided with a depressurization opening capable of communicating with the working chamber, wherein the depressurization opening is connected via a valve to the reduced pressure system. Such a configuration enables the interior of the working chamber to be easily depressurized when the opening part is sealed by the covering part. Also in case of not sealing the working chamber, a depressurization of the interior of the washing tank is possible if the washing tank has pressure resistance.

In the covering part, there may be provided an introduction opening for the washing liquid, wherein the introduction opening is capable of communicating with the working chamber and connected by piping via a valve and a filter to the washing liquid in the washing tank. Such a configuration enables precision washing with constantly pure, filtered washing liquid, by introducing filtered washing liquid via the filter into the working chamber, releasing polluted washing liquid after immersion washing into the washing tank, and again introducing it via the filter into the washing chamber in repetition. Note that for the introduction of the washing liquid from the washing tank to the working chamber, a fluid pump may be installed in the path, or the interior of the working chamber may be depressurized by the reduced pressure system, such that washing liquid is introduced by the negative pressure from the washing tank via the filter to the working chamber.

In the covering part, there may be provided a vapor introduction opening capable of communicating with the working chamber, wherein the vapor introduction opening is connected via a valve to a vapor generation tank. Such a configuration enables introducing washing vapor into working chamber after sealing it with the covering part, whereby it becomes possible to independently perform atmospheric pressure vapor washing and reduced pressure vapor washing without undergoing influence from the washing tank.

The covering part may furthermore be arranged higher than the liquid level of the washing liquid. Such a configuration enables swiftly performing reduced pressure drying of the object to be washed, without withdrawing the washing liquid from the washing tank, by transferring the working chamber to the covering part position to seal it.

The covering part may also be configured, in a case of being arranged in the washing liquid to seal the working chamber in order to perform a reduced pressure drying operation, to perform the same after withdrawing the washing liquid from the washing tank. In this case, while the effort of withdrawing the washing liquid from the washing tank is required, the vertical dimension of the washing tank is enabled to be made smaller, making possible a miniaturization of the apparatus, because an upper space for avoiding contact of the covering part with the washing liquid becomes unnecessary. Further, if the position of the working chamber is arranged at a position higher by a small amount than the bottom base of the washing tank, the interior of the working chamber will be sealed and shut off from the interior of the washing tank by the covering part even in a case where the washing liquid inside the washing tank cannot completely be withdrawn, such that no problems arise for the reduced pressure drying operation. Moreover, because the working chamber by being sealed with the covering part is capable of forming a drying chamber which is shut off from the washing tank, reduced pressure drying in a situation where washing liquid and washing vapor are present in the washing tank becomes possible.

### EFFECT OF THE INVENTION

Since the present invention, as described above, provides a working chamber for performing an operation of washing an object to be washed, so as to be vertically movable within a washing tank loaded with a washing liquid for the object to be washed in a bottom base thereof, and be airtightly shut off separately from the washing tank, a minimal space required for an operation of washing the object to be washed such as reduced pressure drying can be provided, and reduced pressure drying can be efficiently performed in the presence of washing liquid or washing vapor in the washing tank without unnecessary burden on a reduced pressure system.

Further, because in this way the working chamber is provided airtightly shut off from the washing tank, operations under reduced pressure such as reduced pressure drying, reduced pressure ultrasonic washing, and reduced pressure vapor washing are enabled even if the washing tank is of an atmospheric pressure configuration without pressure resistance. Also, because the working chamber can be made independent from the washing tank, there are easily enabled not only reduced pressure related operations as mentioned above, but also various washing operations such as performing immersion washing separately from the washing tank by filtering the washing liquid in the washing tank to introduce highly purified washing liquid into the working chamber, or performing reduced pressure vapor washing by introducing washing vapor into the working chamber.

Further, because the working chamber for loading an object to be washed has an openable and closable opening part formed in a side face in the vertical movement direction, swarf and sludge, which due to the washing operation separate from the object to be washed, become difficult to get caught in the opening part or a packing provided at the opening part, such that causing poor airtightness when being sealed by the covering part is enabled to be prevented.

### BRIEF EXPLANATION OF THE DRAWINGS

FIG. 1 is a cross-sectional drawing of Embodiment 1 of the present invention, showing a situation before a washing operation is begun.

FIG. 2 is a cross-sectional drawing of Embodiment 1 of the present invention, showing a situation where a working chamber has been inserted into an immersion washing section.

FIG. 3 is a cross-sectional drawing of Embodiment 1 of the present invention, showing a situation where the working chamber has been transferred to the surface of the washing liquid, and vapor washing is performed.

FIG. 4 is a cross-sectional drawing of Embodiment 1 of the present invention, showing a situation where the working chamber has been sealed by covering parts, and reduced pressure drying is performed.

FIG. 5 is a cross-sectional drawing of Embodiment 1 of the present invention, showing a situation where an object to be washed for which washing has completed is unloaded from the working chamber.

FIG. 6 is a cross-sectional drawing of FIG. 2 from the right.

FIG. 7 is a cross-sectional drawing of Embodiment 2 of the present invention, showing a situation where a working chamber has been inserted into a washing tank wherein washing liquid has been heated.

FIG. 8 is a cross-sectional drawing of Embodiment 2 of the present invention, showing a situation where washing liquid filtered by a filter is introduced into the working chamber, which has been transferred to the surface of the washing liquid and sealed with covering parts.

FIG. 9 is a cross-sectional drawing of Embodiment 2 of the present invention, showing a situation where the washing liquid in the working chamber is being released into the washing tank.

FIG. 10 is a cross-sectional drawing of Embodiment 2 of the present invention, showing a vapor washing situation.

FIG. 11 is a cross-sectional drawing of Embodiment 3 of the present invention, showing a situation where an object to be washed is loaded into the working chamber, a washing tank having been made smaller, arranging the working chamber in a washing liquid accommodating section.

FIG. 12 is a cross-sectional drawing of Embodiment 3 of the present invention, showing a situation of immersion washing the object to be washed.

FIG. 13 is a cross-sectional drawing of Embodiment 3 of the present invention, showing a situation where the washing liquid has been withdrawn from the washing tank to a reserve tank.

FIG. 14 is a cross-sectional drawing of Embodiment 3 of the present invention, showing a vapor washing situation.

FIG. 15 is a cross-sectional drawing of Embodiment 3 of the present invention, showing a situation where the washing liquid has been withdrawn to the reserve tank, the working chamber has been sealed with covering parts, and reduced pressure drying is being performed.

FIG. 16 is a cross-sectional drawing of Embodiment 4 of the present invention, showing a situation with an opening part formed only on one side of the working chamber.

### EMBODIMENT 1

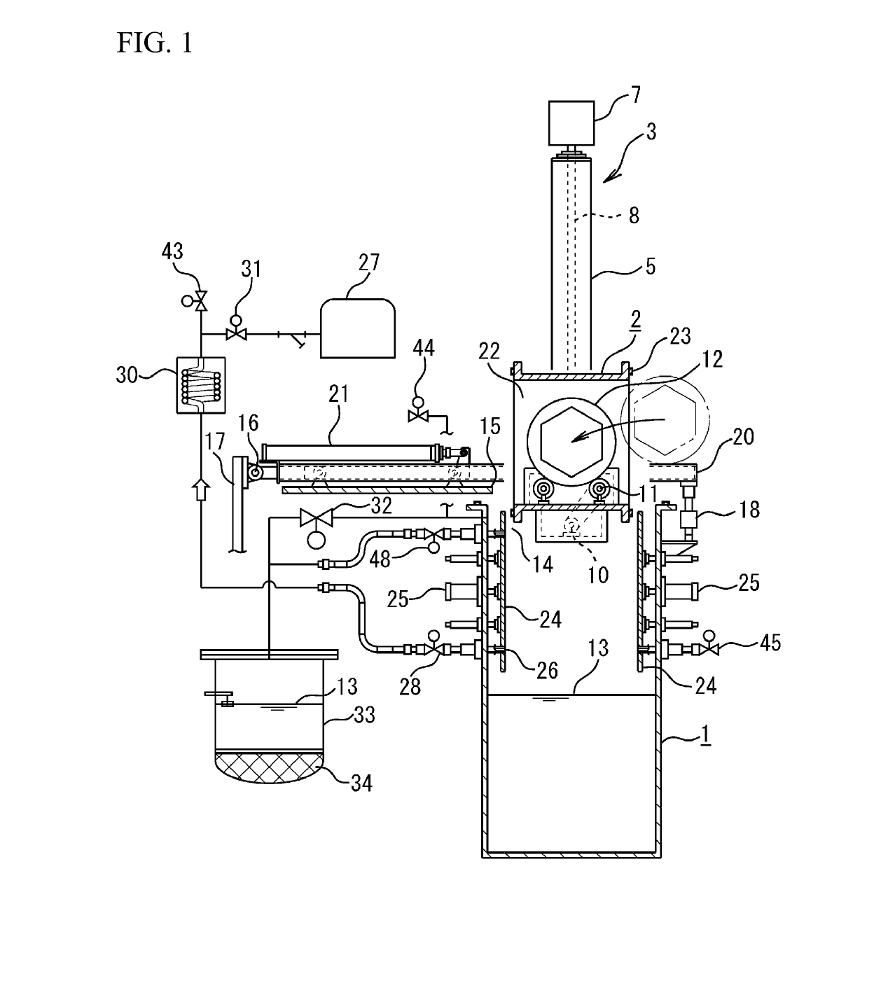

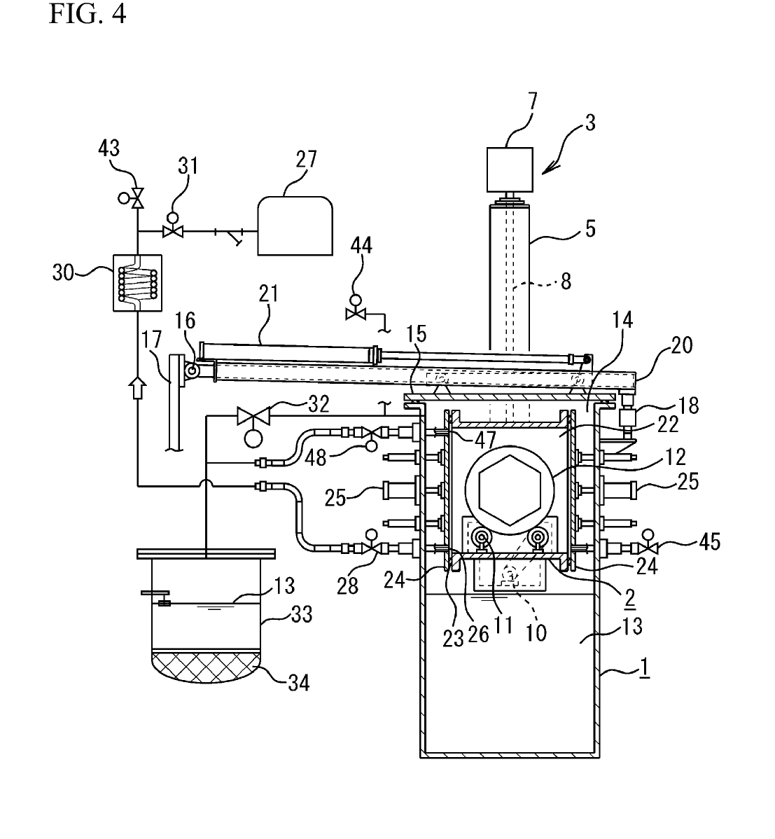

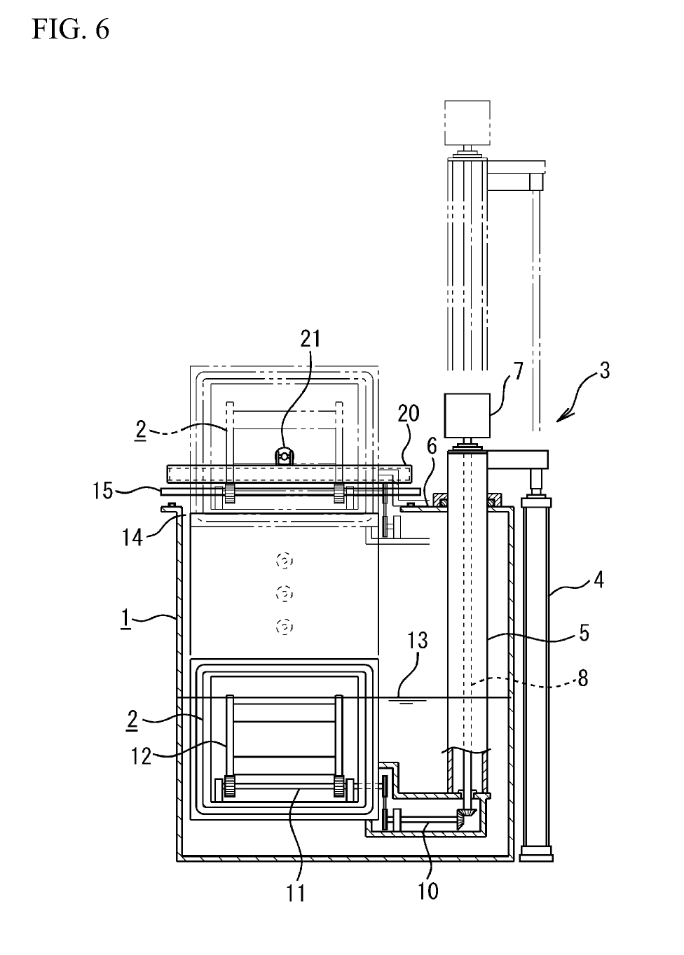

To explain in the following Embodiment 1 of the present invention with reference to FIGS. 1 to 6, (1) is a washing tank, which either comprises pressure resistance or is formed as an atmospheric pressure type lacking pressure resistance, wherein said pressure resistance or an atmospheric pressure type are used selectively in appropriate accordance with the washing purpose. Within the washing tank (1), a pressure-resistant working chamber (2) is arranged to be vertically movable by being connected to a vertical movement mechanism (3). As shown in FIG. 6, the vertical movement mechanism (3) includes a vertical movement body (5) disposed in vertical direction through a top plate (6) of the washing tank (1), for moving up and down in connection with a vertical movement cylinder (4) placed outside the washing tank (1), together with a main drive shaft (8) driven by a motor (7) installed at the upper end, the main drive shaft (8) being perpendicularly linked to a driven shaft (10) connected to a rotation shaft (11) inside the working chamber (2). By mounting an object to be washed (12) on the rotation shaft (11) and rotating the object to be washed (12), washing efficiency for the object to be washed (12) and a washing liquid (13) is enabled to be raised. It is noted that in the present specification, an object to be washed (12) is used as a concept that includes a washing basket accommodating an object to be washed (12).

Further, the washing tank (1) is provided at the top with a port (14) closable and openable by means of a lid member (15). The lid member (15) is arranged to be movable forward and backward on an angle iron (20) and in this state of arrangement connected to a reciprocating cylinder (21). The angle iron (20) is at one end pivotally supported on a pillar (17) of the main body via a pivotal support part (16) to be rotatable, and at the other end enabled to move up and down by a solenoid coil or similar reciprocating mechanism (18). Then, for opening the port (14), the reciprocating mechanism (18) is extended to lift up the angle iron (20) before contracting in this state the reciprocating cylinder (21) to open the lid member (15), as shown in FIG. 1. Likewise, for sealing the port (14) with the lid member (15), it is sufficient to follow a procedure reverse to the above.

The working chamber (2), which is moved up and down by the vertical movement mechanism (3) as described above, is formed in a tubular shape such as a circular or square tube with opening parts (22) formed by vertically cutting out opposite sides in the vertical movement direction. On the outer face of the opening parts (22), O-rings or similar gaskets (23) are arranged in vertical orientation. Covering parts (24) capable of sealing the opening parts (22) are arranged to face the opening parts (22) in a state when the working chamber (2) is positioned higher than the washing liquid (13) in the washing tank (1). The covering parts (24) are disposed on the inner face of the washing tank (1) where they are movable forward and backward in horizontal direction by opening/closing cylinders (25). Besides, whereas according to the above description gaskets (23) such as O-rings are arranged in vertical orientation on the outer face of the opening parts (22), the gaskets (23) do not necessarily have to be formed on the opening parts (22) but may also be formed on the opening part (22) sides of the covering parts (24). In this case it is preferable to form the gaskets (23) broadly with sheet gaskets or the like in order to have them contact the opening parts (22) without fail.

Further, a depressurization opening (26) is formed in the covering parts (24), the depressurization opening (26) being connected via a first open/close valve (28), a condenser (30), and a second open/close valve (31) to a reduced pressure system (27) installed outside the washing tank (1). Besides, while it is a matter of course to form the covering parts (24) with a larger area than the opening parts (22) in order to seal the opening parts (22), a large formation will prevent trouble with sealing the opening parts (22) from occurring even in cases when the stopping position of the working chamber (2) varies due to e.g. a malfunction of the vertical movement mechanism (3). Incidentally, if the covering parts (24) are formed somewhat larger, as described above, the depressurization opening (26) is formed closer in the vertical direction toward the center, such that at the time of sealing the opening parts (22) by the covering parts (24) the depressurization opening (26) communicates with an opening part (22).

In addition, a vapor generation tank (33) is connected to the washing tank (1) via a third open/close valve (32). The vapor generation tank (33) heats the washing liquid (13) by a heating system (34) using heaters, steam etc. to enable supply of washing vapor to the washing tank (1). The vapor generation tank (33) is furthermore connected via a seventh open/close valve (48) to a vapor introduction opening (47) provided in the covering parts (24), for introducing washing vapor into working chamber (2) after sealing, whereby it becomes possible to independently perform atmospheric pressure vapor washing and reduced pressure vapor washing without undergoing influence from the washing tank (1). Incidentally, (43) (44) (45) in the drawings represent decompression release valves.

In order to perform washing of an object to be washed (12) with a configuration as described above, the object to be washed (12) is stored in the washing chamber(2) having been projected out above the washing tank (1), as shown in FIG. 1. In this state of storing, washing liquid (13) is filled into the bottom portion of the washing tank (1). The washing liquid (13) is arbitrarily selectable according to the working objective, where solvents such as petroleum-based solvents, silicone-based solvents, terpenoid solvents, or alcohol-based solvents may be used, or also water may be used. Besides, the first open/close valve (28), second open/close valve (31), and third open/close valve (32) are closed, the reduced pressure system (27) being not activated.

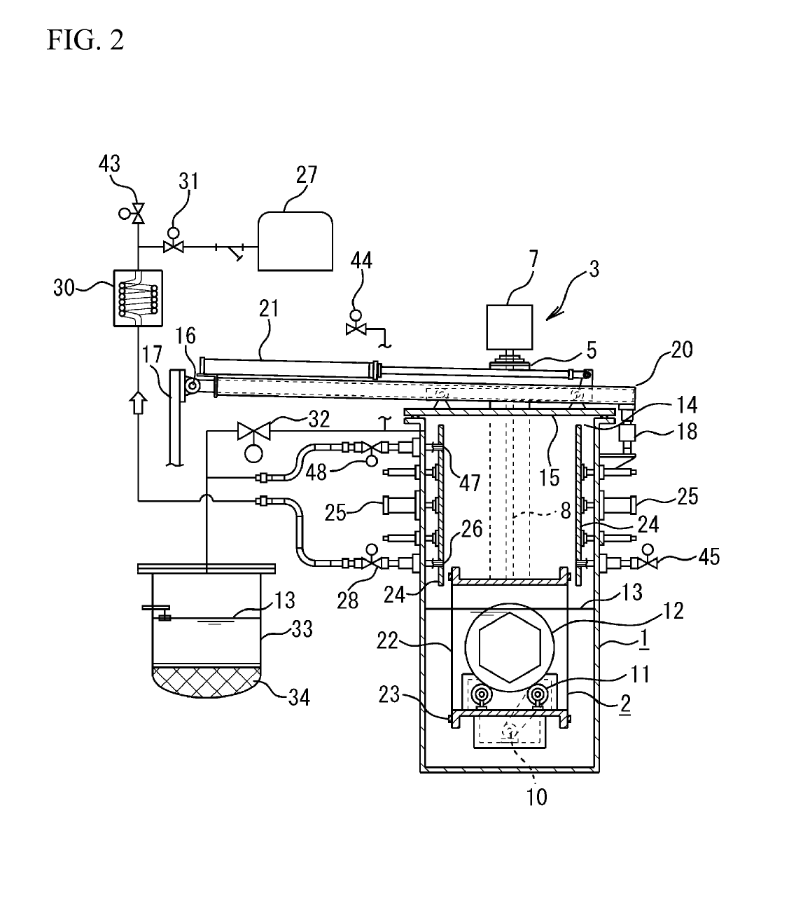

Then, after sealing the port (14) with the lid member (15), as shown in FIG. 2, the working chamber (2) is inserted into the washing liquid (13) by operation of the vertical movement mechanism (3) to perform immersion washing. For the immersion washing, the object to be washed (12) may be rotated by letting the motor (7) of the vertical movement mechanism (3) rotate the rotation shaft (11) or may be shaken by letting the vertical movement cylinder (4) move up and down, where depending on the washing purpose any measure for enhancing contact of the object to be washed (12) with the washing liquid (13) may be taken. Further, by placing an ultrasonic transducer (not shown) in the working chamber (2), ultrasonic cleaning becomes possible as well. Then, by arranging the ultrasonic transducer on the bottom face of the working chamber (2), ultrasonic waves reflected from the top face of the tubular-shape working chamber (2) enable ultrasonic cleaning of the object to be washed (12) also from the upper side. Incidentally, sealing of the opening parts (22) by the covering parts (24) is not performed in this immersion washing. Of course, in this immersion washing it would also be possible to perform sealing of the opening parts (22) by the covering parts (24).

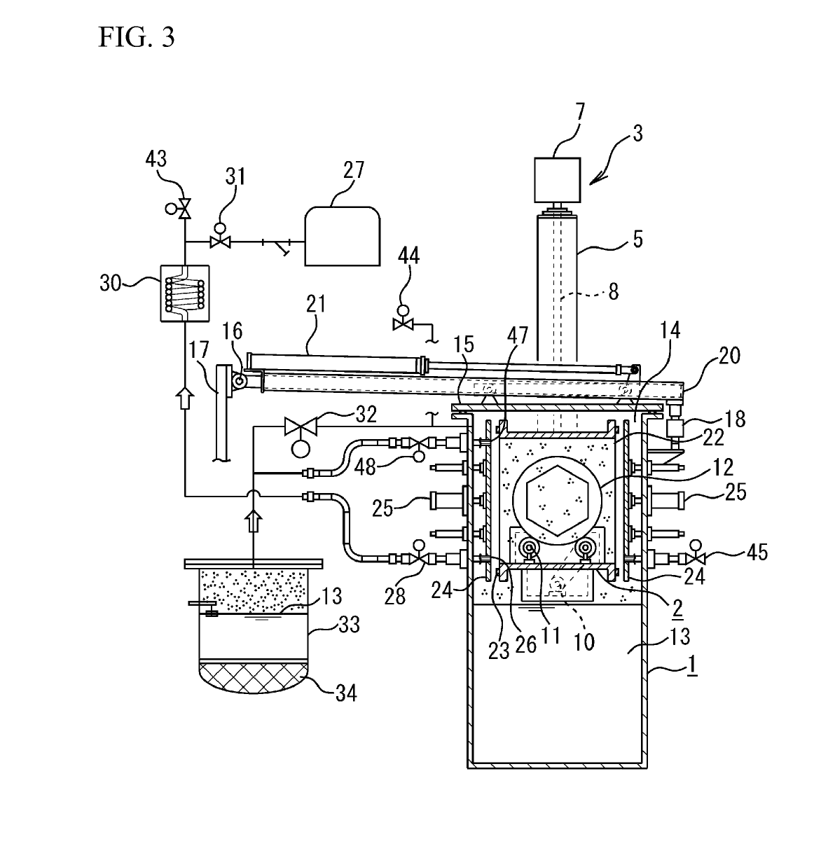

When the immersion washing of the object to be washed (12) is completed, the vertical movement mechanism (3) is operated, as shown in FIG. 3, to lift the working chamber (2) to above the washing liquid (13). By opening the third open/close valve (32) together—in a case where the washing tank (1) has pressure resistance—with opening the first and second open/close valves (28) (31) to let the reduced pressure system (27) depressurize the interior of the washing tank (1), it is possible to introduce washing vapor into the washing tank (1) and perform reduced pressure vapor washing of the object to be washed (12). Washing vapor introduced into the washing tank (1) is introduced through the opening parts (22), which are not sealed by the covering parts (24), into the working chamber (2) where it condenses on the object to be washed (12). By keeping the temperature of the washing liquid (13) as low as possible, the condensation efficiency of the object to be washed (12) and the washing vapor can be improved.

In a case where the washing tank (1) is an atmospheric pressure model not comprising pressure resistance, performing atmospheric pressure vapor washing is enabled by opening only the third open/close valve (32), without activating the reduced pressure system (27), to introduce washing vapor into the washing tank (1). However, even in the case where the washing tank (1) is an atmospheric pressure model not comprising pressure resistance, reduced pressure vapor washing is enabled. In this case, after sealing the working chamber (2) with the covering parts (24), reduced pressure vapor washing is enabled by opening the first open/close valve (28) to let the reduced pressure system (27) depressurize the interior of the working chamber (2), and opening the seventh open/close valve (48) to introduce vapor from the vapor generation tank (33) via the vapor introduction opening (47). Through reducing the amount of oxygen in the air, the performance of vapor washing under a condition of reduced pressure makes it possible to enable high-safety vapor washing even if a solvent having a low ignition point is used.

When the vapor washing of the object to be washed (12) is completed, the open/close cylinders (25) are extended to seal the opening parts (22) by pressing the covering parts (24) against the opening parts (22), and by opening the first and second open/close valves (28) (31), the reduced pressure system (27) is activated to enable reduced pressure drying of the object to be washed (12) in the working chamber (2). Rather than by top/bottom partitioning the washing tank (1), the reduced pressure drying is performed using the space formed by the tubular working chamber (2) and the covering parts (24), which seal the working chamber (2). This enables configuring the working space to the required minimum without being affected by the diameter of the washing tank (1) or the like, such that no more load than needed is placed on the reduced pressure system (27), making it possible to inexpensively perform efficient reduced pressure drying. Also, because the working chamber (2) for performing the operation of washing the object to be washed (12) is formed by shutting it off airtightly separately from the washing tank (1), it becomes possible to efficiently perform reduced pressure drying without letting a wasteful load be placed on the reduced pressure system (27) in a state where washing liquid (13) or washing vapor are present in the washing tank (1). Further, because the working chamber (2) is formed in this way by airtightly shutting it off from the washing tank (1), reduced pressure drying and reduced pressure related work in the working chamber (2) are enabled even if the washing tank (1) is of an atmospheric pressure configuration not comprising pressure resistance. Thus, the working chamber (2) of course is to be used not only for reduced pressure drying but enables various washing operations apart from reduced pressure drying.

Further, by forming the covering parts (24) somewhat larger than the opening parts (22) it is possible to enable reliable sealing even under the assumption that the stopping position of the working chamber (2) due to the vertical movement mechanism (3) slightly deviates from the designed value. In this case, the depressurization opening (26) can be enabled to always communicate with the opening part (22) of the working chamber (2), even if a positional deviation occurs, by forming the depressurization opening (26) toward the center of the covering part (24).

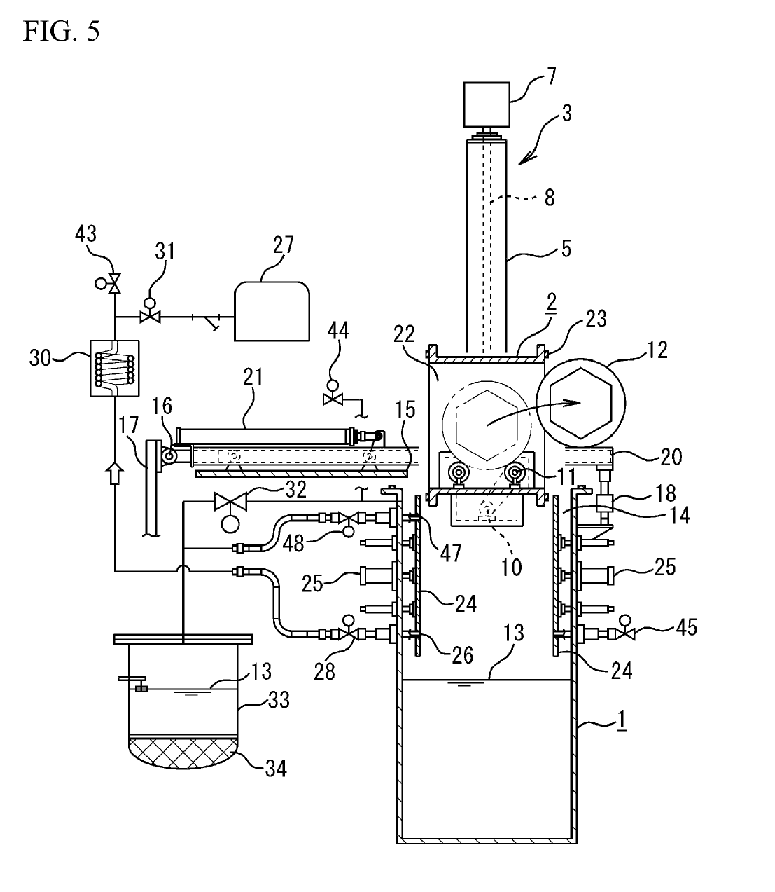

Further, because the opening parts (22) of the working chamber (2) are formed on vertically oriented sides of the working chamber (2), swarf and sludge, which depending on the washing operation separate from the object to be washed (12), hardly pile up or get caught in the opening parts (22) but almost wholly fall down within the washing tank (1) without causing sealing problems. Then, after the reduced pressure drying is finished, after opening the lid member (15), as shown in FIG. 5, the working chamber (2) is enabled to be brought out from the port (14) by the vertical movement mechanism (3).

### EMBODIMENT 2

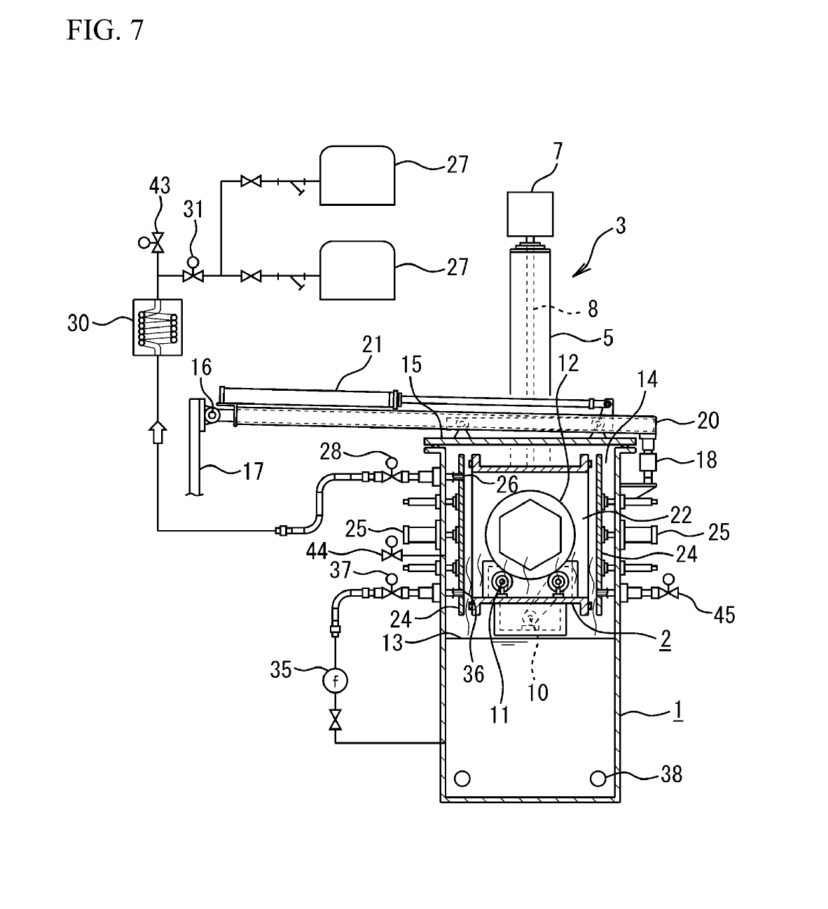

With Embodiment 1 above, an embodiment has been explained wherein immersion washing of an object to be washed (12) is performed by inserting the object to be washed (12) into washing liquid (13) filled into the bottom base of the washing tank (1). In Embodiment 2, the work chamber (2) is transferred to the surface of the washing liquid (13) to perform precision washing of the object to be washed (12) with washing liquid (13) purified by filtration with a filter (35). To now explain in detail Embodiment 2 with reference to FIGS. 7 to 10, the point that the covering parts (24) are positioned higher than the liquid level of the washing liquid (13) is identical to Embodiment 1, while an introduction opening (36) for washing liquid (13) is provided in the covering parts (24), the introduction opening (36) being able to communicate with the working chamber (2) and connected by piping via a fourth open/close valve (37) and the filter (35) to the washing liquid (13) in the washing tank 1 (as shown in FIG. 7).

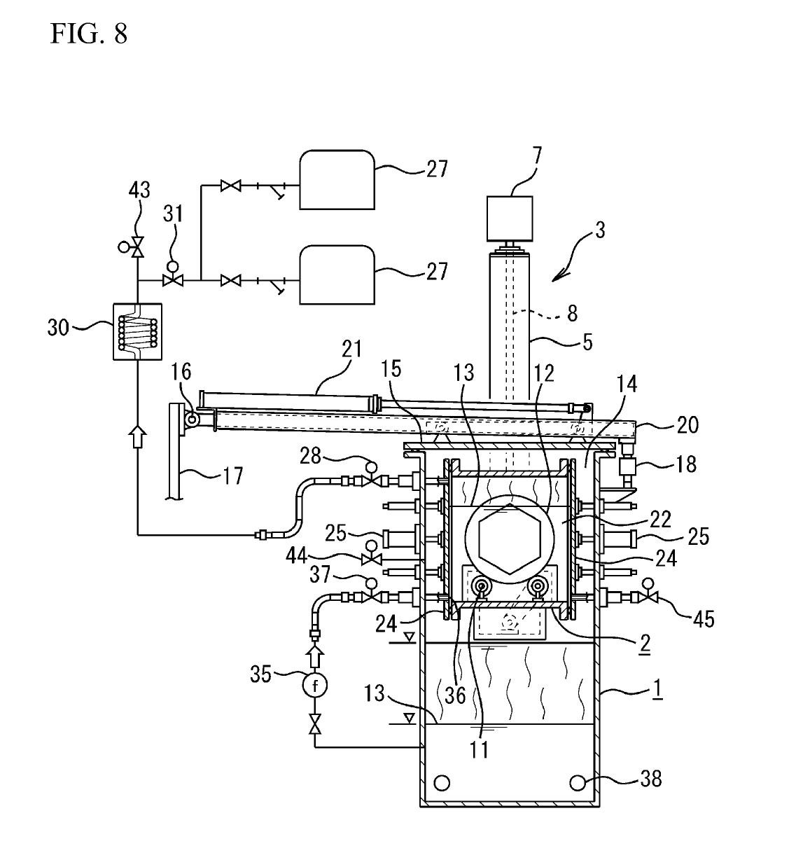

In order to perform a washing operation in Embodiment 2, the working chamber (2) loaded with the object to be washed (12) is arranged at the surface of the washing liquid (13) as shown in FIG. 7. Next, the opening parts (22) of the working chamber (2) are sealed with the covering parts (24), the first and second open/close valves (28) (31) are opened in a condition where the fourth open/close valve (37) is closed, and the reduced pressure system (27) is activated to depressurize the working chamber (2) to a fixed degree of depressurization. By opening the fourth open/close valve (37) in this reduced pressure state, washing liquid (13) inside the washing tank (1) is in one go introduced via the filter (35) into the working chamber (2), as shown in FIG. 8. After that, it is possible to select arbitrary means such as reciprocating the vertical movement cylinder (4) or rotating the object to be washed (12) as in Embodiment 1 by activating the motor (7) to perform immersion washing, ultrasonic washing or the like. During the immersion washing, the first and second open/close valves (28) (31) are closed as well as the fourth open/close valve (37). Or, if the immersion washing is to be reduced pressure ultrasonic washing, the first and second open/close valves (28) (31) are opened, letting ultrasonic vibrations be generated while the reduced pressure system (27) is in operation. Furthermore, by opening the first and second open/close valves (28) (31) in a condition where the fourth open/close valve (37) is open, and activating the reduced pressure system (27), it is of course also possible to introduce washing liquid (13) little by little according to the degree of depressurization. Incidentally, in Embodiment 2 the reduced pressure system (27) is doubly arranged in order to raise the depressurization performance.

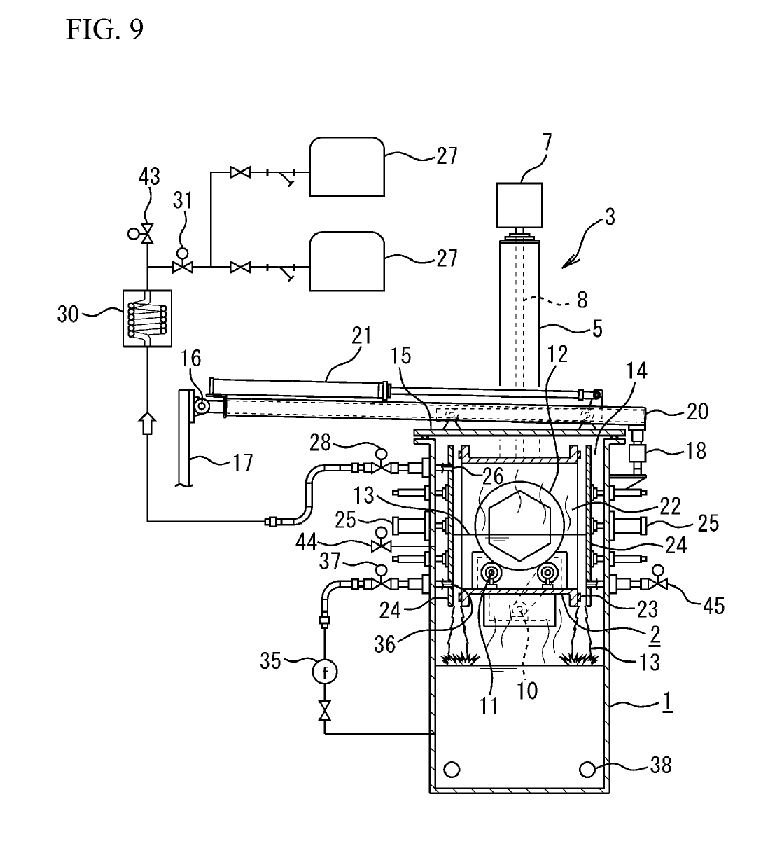

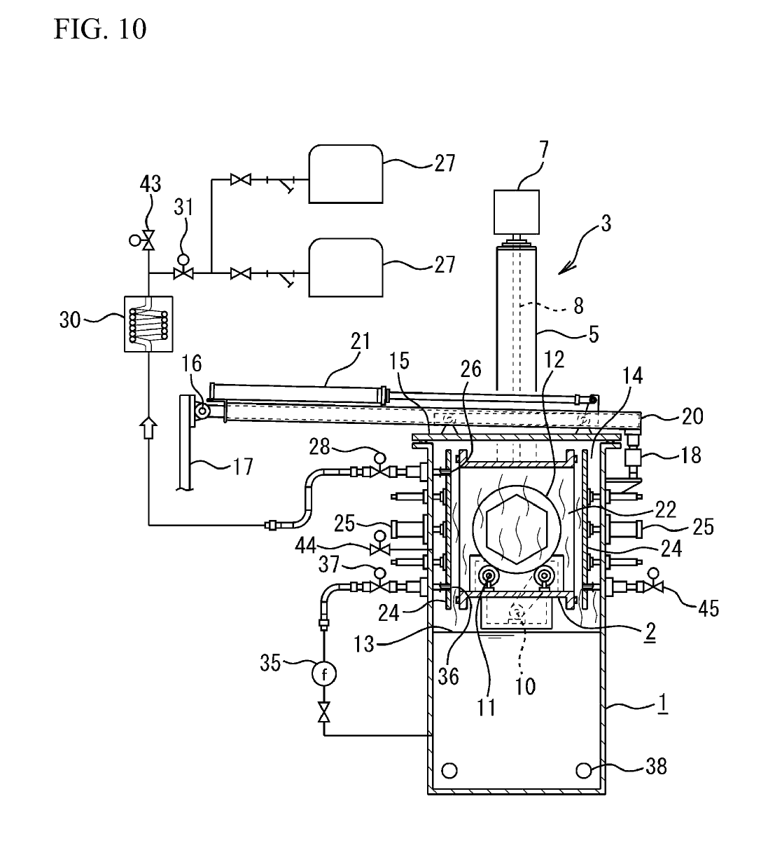

Next, after a certain time of immersion washing, the sealing of the working chamber (2) by the covering parts (24) is released to discharge the washing liquid (13) inside the working chamber (2) into the washing tank (1), as shown in FIG. 9. After the discharge, the working chamber (2) again is sealed by the covering parts (24), and washing liquid (13) inside the washing tank (1) introduced via the filter (35) into the working chamber (2), according to the same procedure as described above. Because repeating the procedure multiple times enables constantly washing the object to be washed (12) with washing liquid (13) purified by the filter (35), highly precise washing of electronic components and the like is enabled to be made possible. After completion of the immersion washing, the washing liquid (13) is heated by a heater (38) to perform vapor washing in a state where the covering parts (24) are open, as shown in FIG. 10. While the vapor washing may be performed under conditions of atmospheric pressure, performing reduced pressure vapor washing is also possible if the washing tank (1) is configured with pressure resistance. In case of the vapor washing being performed at atmospheric pressure, it becomes possible to provide an inexpensive apparatus because the washing tank (1) need not be configured with pressure resistance. Again, configuring the washing tank (1) with pressure resistance enables, even when using an inflammable washing liquid (13), to decrease the risk of catching fire because it is possible to perform reduced pressure vapor washing in a state where the interior of the washing tank (1) has been depressurized.

Then, after completion of the vapor washing, the working chamber (2) is sealed by the covering parts (24), and the reduced pressure system (27) is activated to perform reduced pressure drying. Or, if reduced pressure vapor washing in the working chamber (2) shall be performed, this becomes possible by connecting the vapor generation tank (33) to the covering parts (24) as in Embodiment 1.

### EMBODIMENT 3

In Embodiments 1 and 2 described above, the vertical dimension of the washing tank (1) had been made high, thereby enabling to position the working chamber (2) higher than the liquid level of the washing liquid (13). Such a configuration obviates the need to withdraw the washing liquid (13) from the washing tank (1) when performing reduced pressure drying etc., and enables to swiftly perform changeovers from an immersion washing operation to a vapor washing operation or a reduced pressure drying operation. However, with the vertical dimension of the washing tank (1) being made large, cases arise where depending on the place of installation the apparatus becomes difficult to install. Accordingly, Embodiment 3 is intended to facilitate the installation of the washing apparatus by making the vertical dimension of the cleaning tank (1) small.

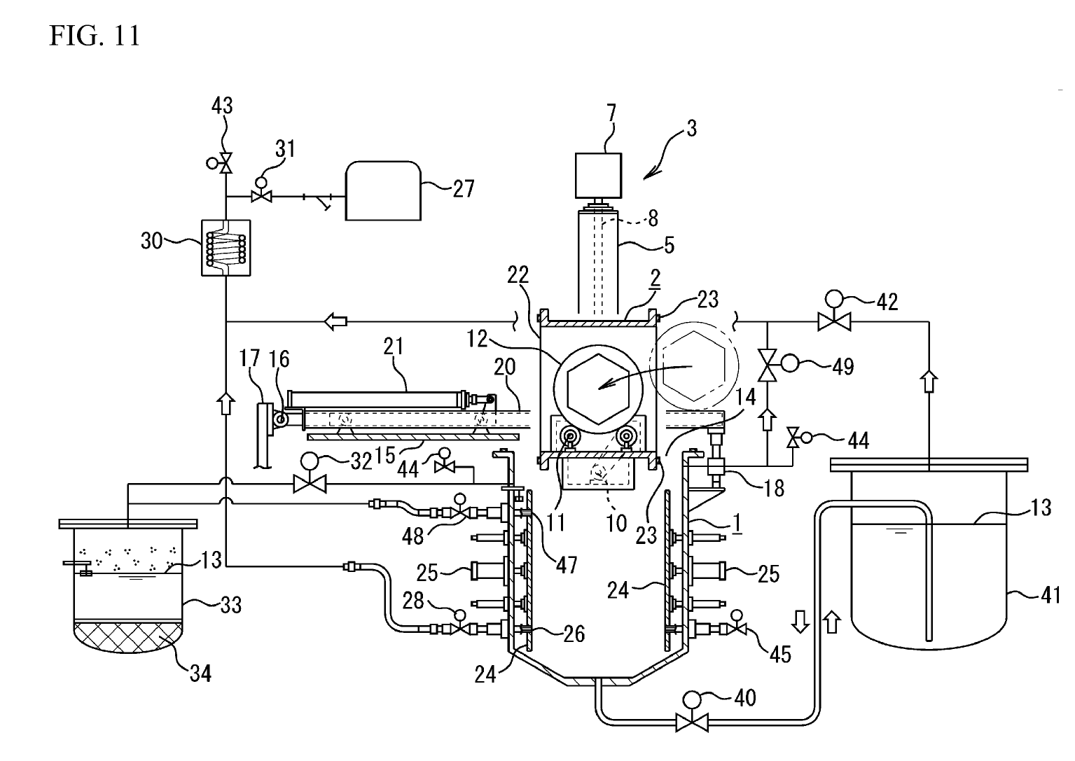

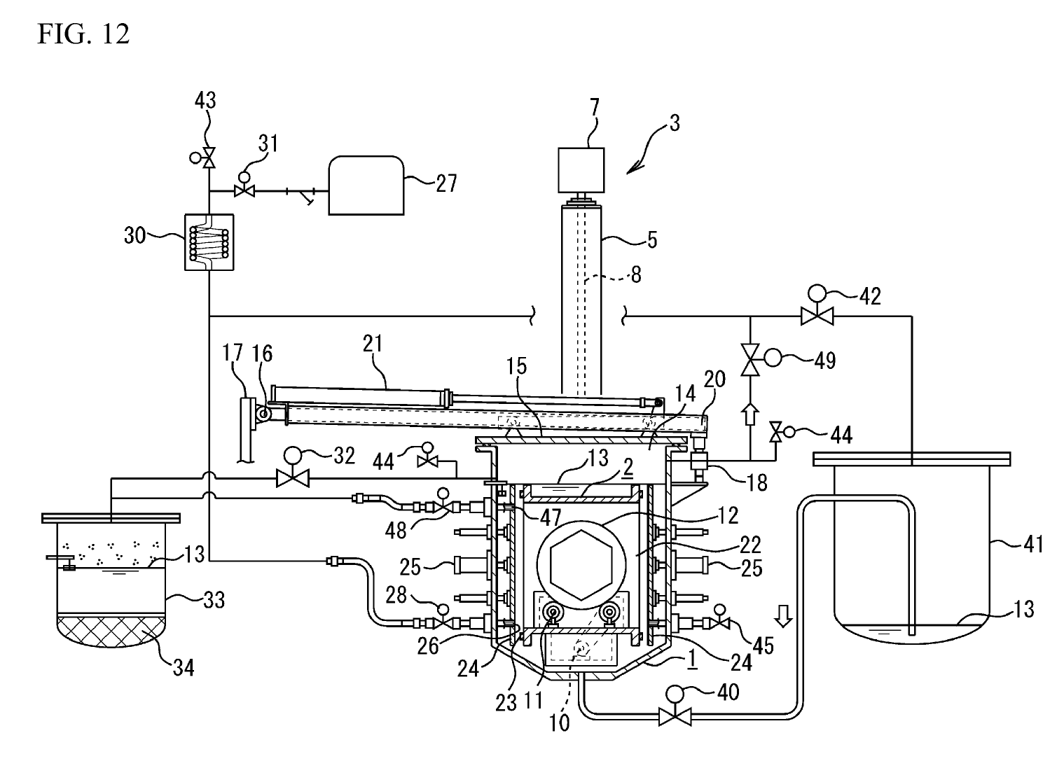

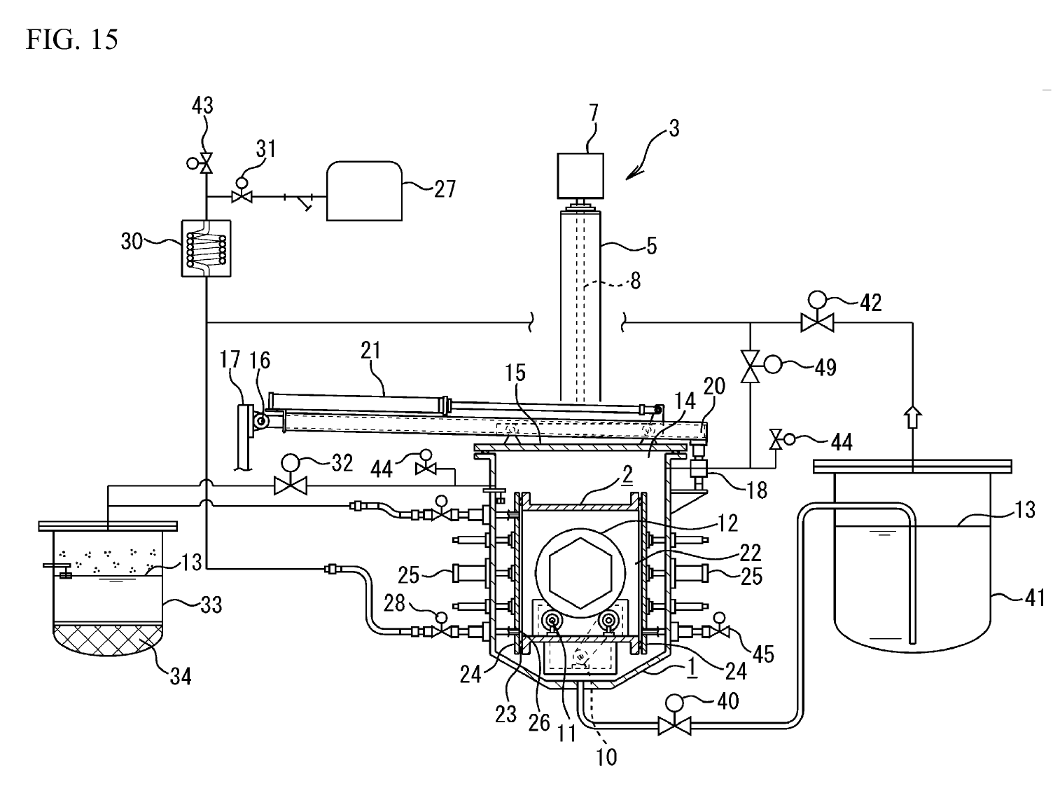

Hereinafter, Embodiment 3 will be described in detail with reference to FIGS. 11 to 15. As mentioned above, the washing tank (1) has no room formed for arranging, in a state filled with washing liquid (1), the working chamber (2) higher than the liquid level. Instead, in a state where washing liquid (13) has been filled into the washing tank (1), the working chamber (2) comes to be arranged in the washing liquid (13) as shown in FIG. 12. Further, the washing tank (1) is connected via a fifth open/close valve (40) to a reserve tank (41), with the reserve tank (41) being connected via a sixth open/close valve (42) and a condenser (30) to the reduced pressure system (27). Also, a vapor generation tank (33) is connected to the washing tank (1) in the same way as in Embodiment 1. For loading an object to be washed (12) into the working chamber (2), the washing liquid (13) is withdrawn to the reserve tank (41), and the working chamber (2) moved above the washing tank (1) before the object to be washed (12) is loaded thereinto as shown in FIG. 11.

The withdrawal of the washing liquid (13) is carried out by closing the fifth open/close valve (40), opening the second and sixth open/close valves (31) (42), and activating the reduced pressure system (27) to depressurize the interior of the reserve tank (41) to a fixed degree of depressurization, followed by opening the fifth open/close valve (40) to transfer the washing liquid (13) to the reserve tank (41) all at once. Then, after lowering the working chamber (2) to arrange it within the washing tank (1), the washing liquid (13) in the reserve tank (41) is transferred into the washing tank (1). This transfer is performed after sealing the washing tank (1) with the lid member (15). Note that the above-described withdrawal of the washing liquid (13) may also be carried out by activating the reduced pressure system (27) while leaving the fifth open/close valve open, to transfer the washing liquid (13) to the reserve tank (41) little by little as the reserve tank (41) is gradually depressurized.

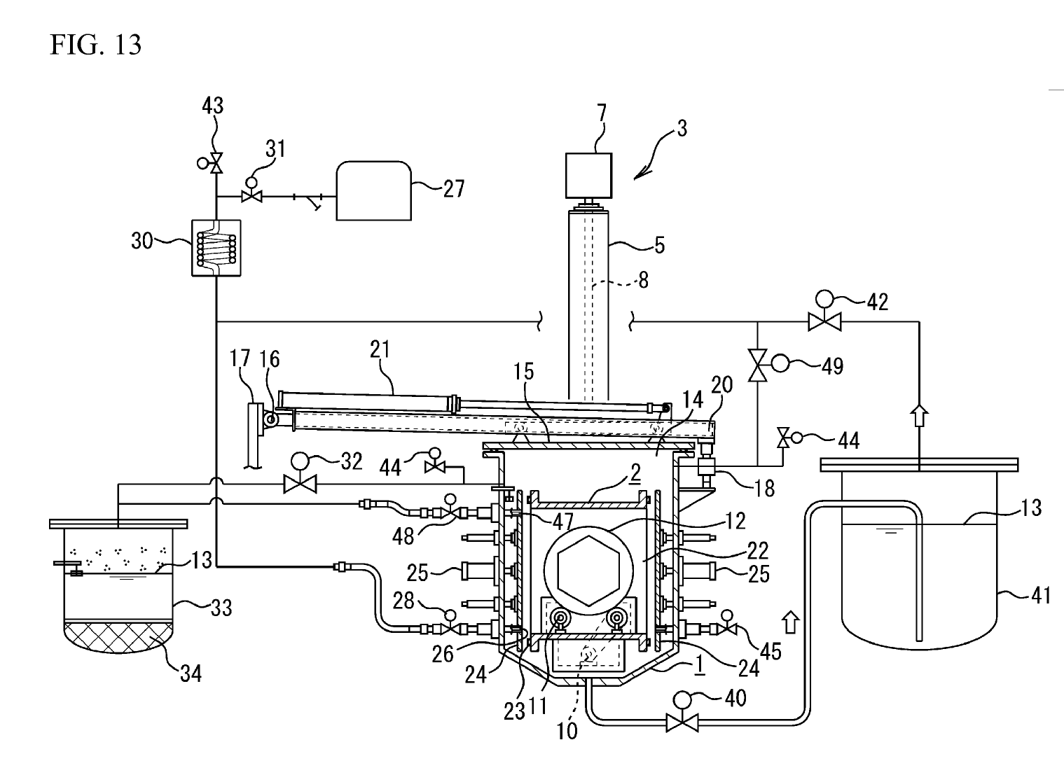

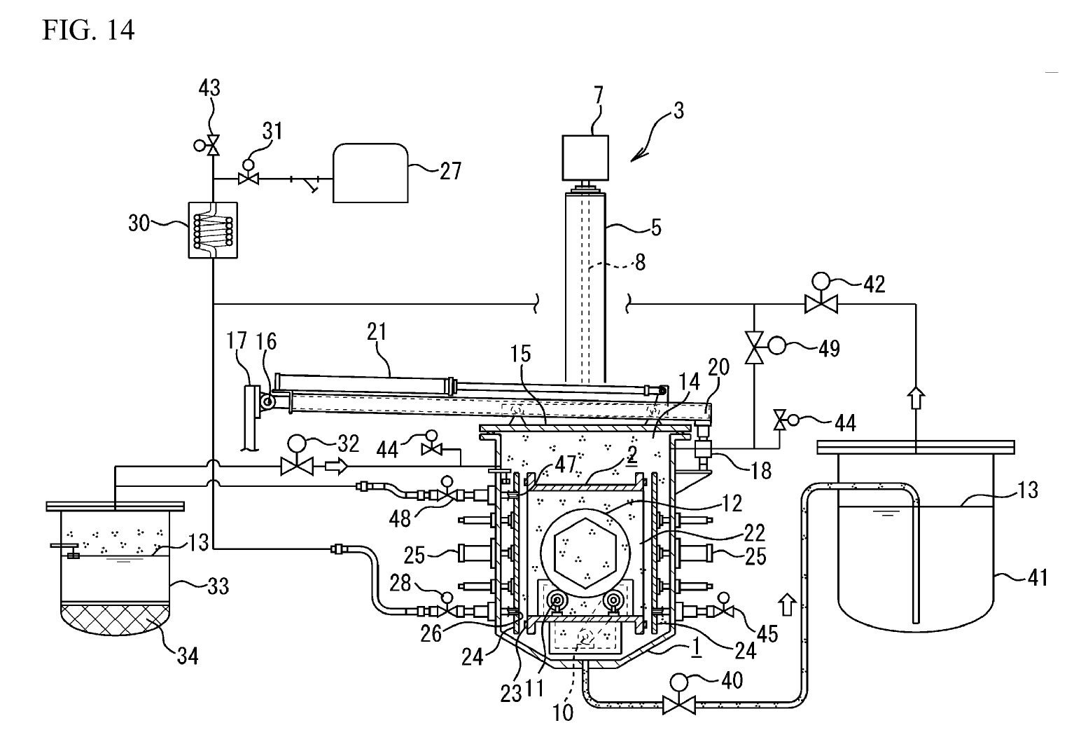

Next, immersion washing of the object to be washed (12) is performed by using, according to the washing purpose, arbitrary methods such as rotation, shaking, or ultrasound, wherein arbitrary means such as moving the vertical movement cylinder (4) up and down or activating the motor (7) are selected. Following completion of the immersion washing, after the washing liquid (13) has been withdrawn to the reserve tank (41) as shown in FIG. 13, vapor washing is performed by introducing washing vapor from the vapor generation tank (33) via the washing tank (1) into the working chamber (2) as shown in FIG. 14. As this vapor washing, in a case where the washing tank is pressure-resistant as in Embodiments 1 and 2, reduced pressure vapor washing of the object to be washed (12) can be performed by opening the first and second open/close valves (28) (31) to let the reduced pressure system (27) depressurize the interior of the washing tank (1) via the depressurization opening (26).

Then, while washing vapor introduced into the washing tank (1) is introduced through the opening parts (22), which are not sealed by the covering parts (24), into the working chamber (2) where it condenses on the object to be washed (12), the condensation efficiency of the object to be washed (12) and the washing vapor can be improved by keeping the temperature of the washing liquid (13) as low as possible. Further, this reduced pressure vapor washing in the washing tank (1) may also be performed, as shown in FIGS. 11 to 14, by directly connecting the washing tank (1) via an eighth open/close valve (49) to the reduced pressure system (27). This direct connection of the washing tank (1) to the reduced pressure system (27) may, if the washing tank (1) comprises pressure resistance, be performed in the same way also in Embodiments 1 and 2.

Further, in a case where the washing tank (1) is an atmospheric pressure model not comprising pressure resistance, performing atmospheric pressure vapor washing is enabled by opening only the third open/close valve (32), without activating the reduced pressure system (27), to introduce washing vapor into the washing tank (1). However, even in the case where the washing tank (1) is an atmospheric pressure model not comprising pressure resistance, reduced pressure vapor washing is enabled. In this case, after sealing the working chamber (2) with the covering parts (24), reduced pressure vapor washing is enabled by opening the first open/close valve (28) to let the reduced pressure system (27) depressurize the interior of the working chamber (2), and opening the seventh open/close valve (48) to introduce vapor from the vapor generation tank (33) via the vapor introduction opening (47). Through reducing the amount of oxygen in the air, the performance of vapor washing under a condition of reduced pressure makes it possible to enable high-safety vapor washing even if a solvent having a low ignition point is used.

When the vapor washing has completed, closing the opening parts (22) of the working chamber (2) with the covering parts (24) and depressurizing the working chamber (2) through the depressurization opening (26) by the reduced pressure system (27) enables to perform drying by lowering the boiling point of the washing liquid (13). Further, the withdrawal of the washing liquid (13) from the washing tank (1) need not be performed completely but is sufficiently performed if to an extent where no washing liquid (13) remains in the working chamber (2). To the reduced pressure drying in the independent working chamber (2), it is without any problem if some washing liquid (13) remains in the washing tank (1). Conventionally, reduced pressure drying using the washing tank (1) generated a large load on the reduced pressure system (27) due to residual liquid occurring because it was difficult to completely withdraw the washing liquid (13) from the washing tank (1). However, because in Embodiment 3 the working chamber (2) is formed independently of the washing tank (1), there is not any hindrance even if some washing liquid (13) remains behind in the washing tank (1) if the withdrawal is performed in such a way that no washing liquid (13) remains inside the working chamber (2).

### EMBODIMENT 4

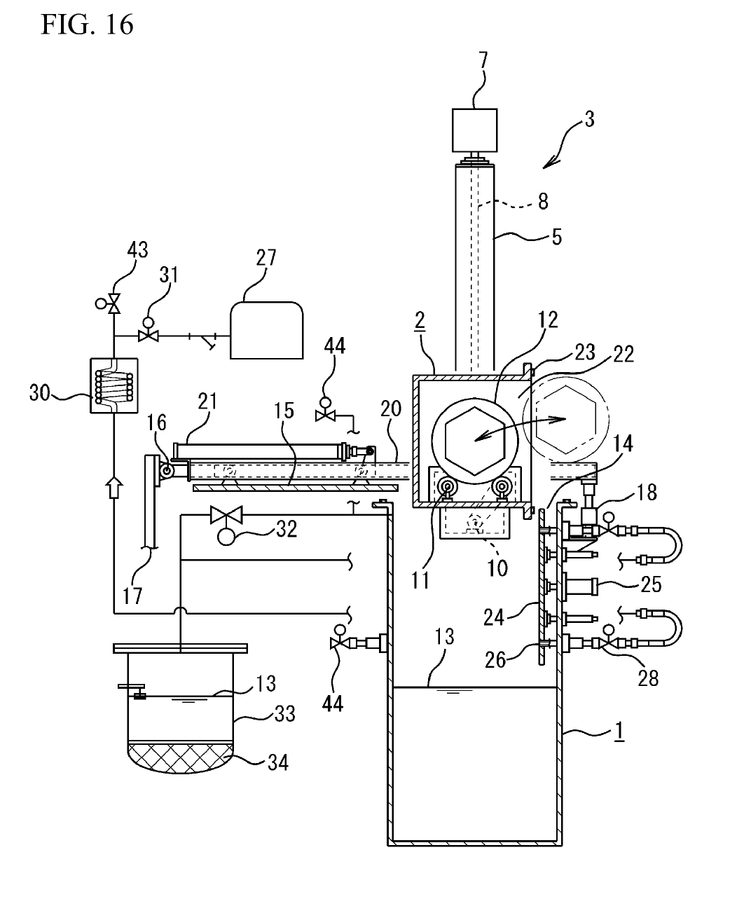

In Embodiments 1 to 3 above, the opening parts (22) of the working chamber (2) are formed on opposite vertically oriented sides. Because forming them in this way enables loading and unloading of an object to be washed (12) from both left and right, this has an advantage of improving the operability. However, the apparatus is rendered expensive since the sealing of the working chamber (2) requires two covering parts (24), while a lot of attention and maintenance is required also with regard to preventing leakages against airtightness due to poor contact between the lid member (15) covering part (24) and the opening parts (22) of the working chamber (2). In contrast, as shown for Embodiment 4 in FIG. 16, the working chamber (2) is provided with only one opening part (22) on one vertically oriented side, forming a C-shaped cross section. While being formed in this way makes necessary some effort for taking in and out objects to be washed (12), the apparatus can be made inexpensive because sealing the working chamber (2) becomes possible with only one covering part (24), and the probability of leakages against airtightness due to poor contact between the lid member (15) covering part (24) and the opening part (22), the maintenance effort etc. are enabled to be greatly reduced.

### EXPLANATION OF REFERENCE SIGNS

1 washing tank

2 working chamber

12 object to be washed

13 washing liquid

22 opening part

24 covering part

26 depressurization opening

27 reduced pressure system

33 vapor generation tank

35 filter

36 introduction opening

47 vapor introduction opening

1. An apparatus for washing an object to be washed, comprising a pressure-resistant working chamber for loading the object to be washed, wherein the working chamber is movable vertically within a washing tank for loading a washing liquid for the object to be washed into a bottom base thereof and has an openable and closable opening part formed in a side face in the vertical movement direction, and wherein a covering part for enabling an interior of the working chamber to be sealed by covering the opening part in the side face of the working chamber, and for enabling the interior of the working chamber to be depressurized by connecting the interior of the working chamber to a reduced pressure system, is provided on an inner surface of the washing tank so as to be movable horizontally.

2. The apparatus for washing an object to be washed according to claim 1, wherein the washing tank is provided with pressure resistance.

3. The apparatus for washing an object to be washed according to claim 1, wherein the washing tank is configured for use at atmospheric pressure.

4. The apparatus for washing an object to be washed according to claim 1, wherein the opening part of the working chamber is formed vertically in the side face of the working chamber.

5. The apparatus for washing an object to be washed according to claim 1, wherein the opening part of the working chamber is formed as a pair on opposite sides of the working chamber.

6. The apparatus for washing an object to be washed according to claim 1, wherein the opening part of the working chamber is formed singly on only one side of the working chamber.

7. The apparatus for washing an object to be washed according to claim 1, wherein the covering part is provided with a depressurization opening capable of communicating with the working chamber, the depressurization opening being connected via a valve to the reduced pressure system.

8. The apparatus for washing an object to be washed according to claim 1, wherein the covering part is provided with a vapor introduction opening capable of communicating with the working chamber, the vapor introduction opening being connected via a valve to a vapor generation tank.

9. The apparatus for washing an object to be washed according to claim 1, wherein the covering part is provided with an introduction opening for the washing liquid, the introduction opening being capable of communicating with the working chamber and connected by piping via a valve and a filter to the washing liquid in the washing tank.

10. The apparatus for washing an object to be washed according to claim 1, wherein the covering part is arranged higher than a liquid level of the washing liquid.

11. The apparatus for washing an object to be washed according to claim 1, wherein the covering part, in a case of being arranged in the washing liquid to seal the working chamber in order to perform a reduced pressure drying operation, is configured to perform the same after withdrawing the washing liquid from the washing tank.
